(19) United States
(12) Patent Application Publication
(10) Pub. No.: US 2003/0172720 A1
(43) Pub. Date: Sep. 18, 2003

(54) Apparatus for detecting leakage in a fuel rail

(76) Inventors: Emma Sweetland, Henley-on-Thames (GB); Thomas E. Fletcher, Tempe, AZ (US); Eric B. Andrews, Columbus, IN (US); Stacey A. Bowling, Columbus, IN (US)

Correspondence Address: CUMMINS INC., Box 3005, M/C 60701, Columbus, IN, 47202-3005, US

(21) Appl. No.: 09/946,314

(22) Filed: Sep. 5, 2001

(30) Foreign Application Priority Data
Sep. 7, 2000 (GB) 0021923.8

(51) Int. Cl. G01M 3/04

(52) U.S. Cl. 73/49.7

(57) ABSTRACT

A method and apparatus are disclosed for detecting leakage in the fuel supply to the injectors of an engine in which the individual injectors are connected to a fuel supply rail to which fuel from a reservoir is supplied under pressure by a fuel pump. The pressure within the fuel rail is monitored and it is determined when a parameter of a pressure surge in the fuel supply rail resulting from a rapid transition from high to low engine load fails to reach a reference value.

### FIELD OF THE INVENTION

The present invention is concerned with an engine in which individual injectors connected to a common fuel supply rail are used to inject fuel directly into the combustion chambers of the engine.

### BACKGROUND OF THE INVENTION

In such engines, and especially in diesel engines, the fuel rail needs to be maintained under high pressure by a fuel pump and the present invention seeks to provide a method and apparatus for detecting fuel leakage from the fuel rail and the pipes connected to it.

### SUMMARY OF THE INVENTION

According to a first aspect of the present invention, there is provided a method of detecting leakage in the fuel supply to the injectors of an engine in which the individual injectors are connected to a fuel supply rail to which fuel from a reservoir is supplied under pressure by a fuel pump, the method comprising the steps of monitoring the pressure within the fuel rail and determining when a parameter of a pressure surge in the fuel supply rail resulting from a rapid transition from high to low engine load fails to reach a reference value.

According to a second aspect of the invention, there is provided an apparatus for detecting leakage in the fuel supply to the injectors of an engine in which the individual injectors are connected to a fuel supply rail to which fuel from a reservoir is supplied under pressure by a fuel pump, the apparatus comprising means for measuring the pressure within the fuel rail and means for determining when a parameter of a measured pressure surge in the fuel supply rail resulting from a rapid transition from high to low engine load fails to reach a reference value.

In common fuel rail systems, when the load on the engine is reduced (by release of the accelerator pedal), the injectors are immediately turned off and the fuel pump supplying the fuel rail is also commanded to close down. However, because some of the pump chambers will already contain fuel that will be delivered to the rail even after the pump has been commanded to close down, the pressure in the fuel rail increases for a short time and then slowly decays. The invention is predicated on the realisation that this unavoidable pressure surge, which has hitherto been regarded as a nuisance, can be used to monitor the integrity of the fuel rail. This is because the effect of a leak in the fuel rail of the high pressure lines would be to reduce the peak pressure of the surge and to reduce the time that it takes to decay.

The surge can be measured on such occasions as the accelerator is released suddenly, preferably when the engine is operating at or near full load. The peak pressure and decay time of the surge that should occur under these circumstances will depend on the engine speed. By storing the appropriate values of peak pressure and/or decay time, or the time integral of the pressure surge, in a look-up table, or calculating such reference pressures using a suitable algorithm, it is possible to detect leakage by comparing the respective measured parameter with that stored or calculated for the current engine speed.

It is possible to build-in self-learning or adaptation features in the leakage detection algorithm to take into account such factors as variation in the output of the fuel pump. In particular, the algorithm can be made more efficient by allowing the calibration to learn the characteristics of the particular fuel system during the first few hours of operation. As long as the measured values prove to be within an expected range, then they may serve as a baseline from which changes should be measured.

### BRIEF DESCRIPTION OF THE DRAWINGS

The invention will now be described further, by way of example, with reference to the accompanying drawings, in which:

FIG. 1 shows a schematic representation of an engine control system, embodying the present invention,

FIG. 2 shows a graph of measured rail pressure against time before and after a change in throttle command, and

FIG. 3 shows part of the graph shown in FIG. 2 to an enlarged scale and illustrating the effect of engine speed on the pressure surge in the fuel rail.

### DETAILED DESCRIPTION OF THE PREFERRED EMBODIMENTS

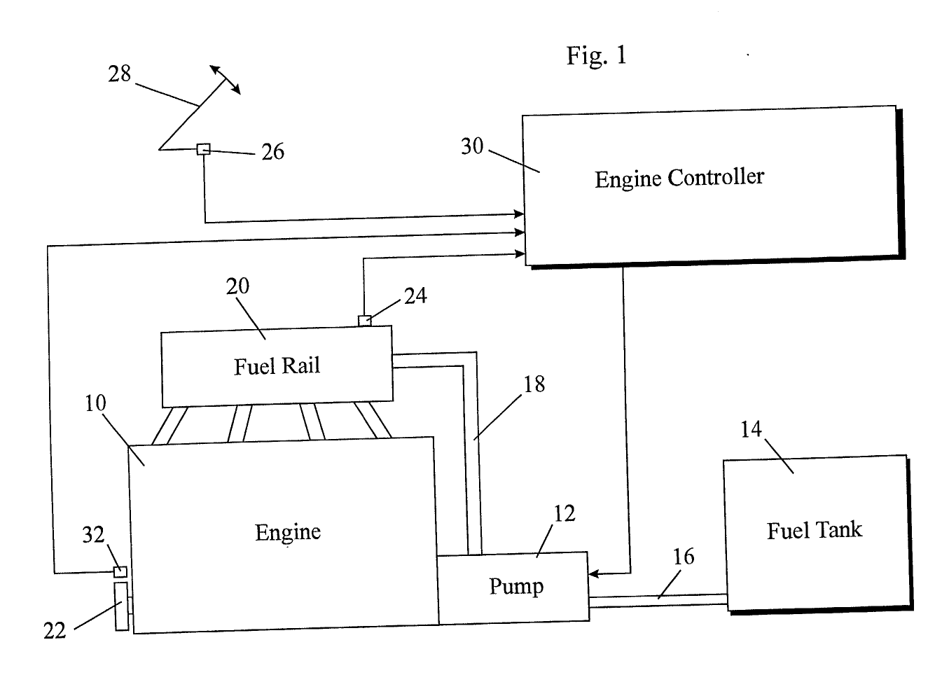

FIG. 1 shows a diesel engine 10 having a fuel pump 12 that draws fuel from a tank 14 by way of a pipe 16 and supplies fuel under pressure to a fuel rail 20 by way of a pipe 18. From the fuel rail 20, fuel flows to the individual injectors (not shown). The pump 12 is controlled by an engine controller 30 which receives inputs from various sensors, amongst them a pressure sensor 24 detecting the pressure in the fuel rail 20, an engine speed/position sensor 32 associated with the crankshaft 22 of the engine 10 and a position sensor 26 sensitive to the position of the accelerator or demand pedal 28. The controller may additionally include a clock to enable it to predict wear in the system.

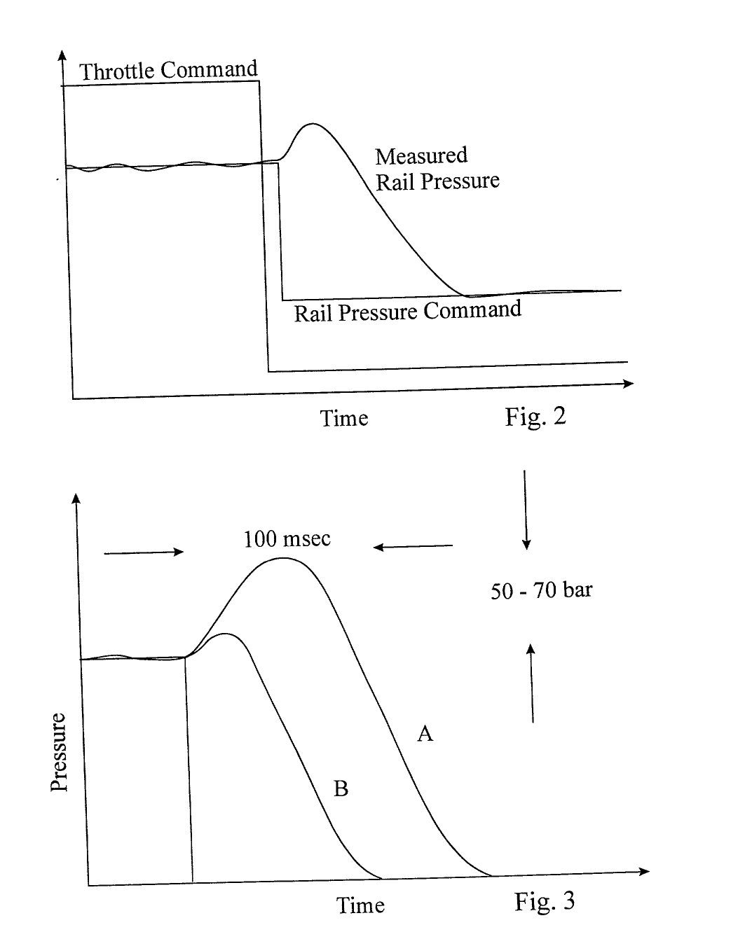

As shown by the graphs in FIGS. 2 and 3, when the driver suddenly reduces the engine load by removing his foot from the demand pedal 28, that is when there is a step change in the throttle command, the controller 30 after a slight delay sends a signal to the fuel pump 12 to reduce its output. However, when the fuel system has no leaks, there is a temporary surge in the pressure in the fuel rail 20 as sensed by the sensor 24 before the pressure drops to the value corresponding to the reduced engine load condition. The reason for this pressure surge, as earlier explained, is that some of the pump chambers will still contain fuel that is delivered to the fuel rail after the injectors have been shut off. The present invention makes use of this unavoidable pressure surge, to monitor the integrity of the fuel rail because its peak and/or duration would be reduced in the event of a leak in the fuel rail.

To avoid errors, it is important to ensure that surge monitoring only takes place when a transition from above a first value of engine load to below a second value of engine load occurs within a predetermined time. In other words, one must ensure that a significant and sudden drop in engine load has occurred.

In FIG. 3, the curve A shows the pressure variation in the fuel rail when the accelerator pedal is released with the engine running at 2500 rpm while the curve B shows the pressure variation if the release of the accelerator pedal occurs with the engine running at 700 rpm. Because of these variations, it is not possible to specify a fixed limit for the magnitude and/or duration of these pressure surges as they will depend on other operating parameters such as engine speed. Instead, therefore, the engine controlled 30, which is itself a micro-computer serving several other functions, may be used to store or calculate tables of expected pressure surge magnitude and duration occurring at different speeds (or other engine control parameters affecting the fuel rail pressure surge) and to compare the expected values with actual values sensed by the sensor 24. When the difference between expected and measure surge peaks and/or surge durations drops below a threshold, then the controller 30 can issue a warning of a suspected leak in the fuel rail.

The values of surge pressure and duration may vary between fuel systems and it is possible to compensate for such variation by adopting a self-learning algorithm in the controller 30.

Having thus described the invention, what is claimed as novel and desired to be secured by letters Patent of the U.S. is:

1. A method of detecting leakage in the fuel supply to the injectors of an engine in which the individual injectors are connected to a fuel supply rail to which fuel from a reservoir is supplied under pressure by a fuel pump, the method comprising the steps of monitoring the pressure within the fuel rail and determining when a parameter of a pressure surge in the fuel supply rail resulting from a rapid transition from high to low engine load fails to reach a reference value.

2. A method as claimed in claim 1, wherein the monitored parameter of the pressure surge is the maximum pressure reached during the surge.

3. A method as claimed in claim 1, wherein the monitored parameter of the pressure surge is the duration of the surge.

4. A method as claimed in claim 1, wherein the monitored parameter is the time integral of the pressure during the surge.

5. A method as claimed in claim 1, wherein surge monitoring takes place only when a transition from above a first value of engine load to below a second value of engine load occurs within a predetermined time.

6. A method as claimed in claim 5, wherein the reference value is varied as a function of the engine speed during the pressure surge.

7. A method as claimed in claim 6, wherein a correction factor is applied to the reference value to compensate for variations in fuel system production.

8. Apparatus for detecting leakage in the fuel supply to the injectors of an engine in which the individual injectors are connected to a fuel supply rail to which fuel from a reservoir is supplied under pressure by a fuel pump, the apparatus comprising means for measuring the pressure within the fuel rail and means for determining when a parameter of a measured pressure surge in the fuel supply rail resulting from a rapid transition from high to low engine load fails to reach a reference value.

9. Apparatus as claimed in claim 8, wherein the monitored parameter of the pressure surge is the maximum pressure reached during the surge, the duration of the surge or the time integral of the pressure during the surge.

10. Apparatus as claimed in any of claim 9, comprising means for varying the reference value as a function of an operating condition of the engine such as engine speed, coolant temperature, ambient temperature and fuel temperature during the pressure surge.

11. Apparatus as claimed in claim 10, comprising means for calculating or looking up from a stored table a reference value appropriate to the prevailing engine operating conditions.

12. Apparatus as claimed in claim 11, wherein means are provided for applying a correction to the reference value to compensate for variations in the output of the fuel pump.
